(19) United States
(12) Patent Application Publication
(10) Pub. No.: US 2007/0195947 A1
(43) Pub. Date: Aug. 23, 2007

(54) Procedure in conjunction with making a telecommunication call and a telecommunication terminal arrangement

(76) Inventor: Taina Tuulikki Puumalainen, Oulu (FI)

Correspondence Address: ALTERA LAW GROUP, LLC, 6500 CITY WEST PARKWAY, SUITE 100, MINNEAPOLIS, MN, 55344-7704, US

(21) Appl. No.: 11/646,907

(22) Filed: Dec. 28, 2006

Related U.S. Application Data
(63) Continuation-in-part of application No. 09/341,817, filed on Sep. 7, 1999.

(30) Foreign Application Priority Data
Nov. 17, 1997 (FI) PCT/FI97/00703

(51) Int. Cl. H04M 1/00

(52) U.S. Cl. 379/354

(57) ABSTRACT

The subject of the present invention is a procedure and an equipment arrangement in conjunction with making a telecommunication call. In said procedure implemented in conjunction with making a call, means of searching included in a telecommunication terminal arrangement are used to directly or indirectly at least partly browse through dial numbers stored in said telecommunication terminal arrangement to locate a desired dial number. Means of commanding included in said telecommunication terminal arrangement are used to command a transmitter of said telecommunication terminal to begin making a direct or indirect call to a final, retrieved dial number. According to the present invention, in conjunction with said direct or indirect browsing, graphic information, which identifies the owner of each dial number and which is stored in a graphic memory of said telecommunication terminal arrangement, is displayed on a display of said telecommunication terminal arrangement.

### CROSS REFERENCES TO RELATED APPLICATIONS

This patent is a continuation-in-part and claims the benefit of U.S. patent application Ser. No. 09/341,817 filed Sep. 7, 1999 (Puumalainen, “Procedure in conjunction with making a telecommunication call and a telecommunication terminal arrangement”), which is hereby incorporated herein in its entirety by reference thereto, and also claims the benefit of International Application Number PCT/FI97/00703 filed Nov. 17, 1997 (Puumalainen, “A procedure in conjunction with making a telecommunication call and a telecommunication terminal arrangement”).

### TECHNICAL FIELD

This disclosure relates to improvements in telecommunications terminal devices such as telephones by making them more user friendly with visual and audible files whereby the user can more quickly utilize the device and with less distraction.

### BACKGROUND

The subject of the present invention includes a procedure in conjunction with making a telecommunication call, in which procedure means of searching included in a telecommunication terminal arrangement are used to directly or indirectly at least partly browse through dial numbers stored in said telecommunication terminal arrangement to locate a desired dial number, and means of commanding included in said telecommunication terminal arrangement are used to command a transmitter of said telecommunication terminal arrangement to begin making a direct or indirect call to a final, retrieved dial number and in which procedure, in conjunction with said direct or indirect browsing, graphic information, which identifies the owner of each dial number and which is stored in a graphic memory of said telecommunication terminal arrangement is displayed on a display of said telecommunication terminal arrangement.

The subject of the present invention also includes a telecommunication terminal arrangement, which comprises a transmitter, a dial number memory and means of searching used to locate a desired dial number in said dial number memory, and means of commanding used to command said transmitter to begin making a call to a dial number retrieved from said dial number memory and which arrangement comprises a graphic memory including graphic information which illustrates the owners of said dial numbers included in said dial number memory, which graphic memory is linked to function together with said dial number memory so that while directly or indirectly browsing said dial numbers. Said arrangement displays graphic information related to said owner of said dial number on a display included in said arrangement and/or a display connected to said arrangement.

Because of aging and the complexity and difficulty of using devices, making a phone call is especially difficult for elderly people. For this reason, security phones have been developed which comprise a terminal bracelet connected via a transceiver to an actual terminal device located in an elderly person's residence, which terminal device is connected to a fixed telephone network. The bracelet comprises a button by which a call can be made, e.g., via the actual terminal device connected to the fixed network.

A deficiency of said device is that it can only be used to call a specific number, and said device does not provide clear information about where the call is going, or even information about whether or not the call has left.

Complete cellular network phones integrated into bracelets are known, e.g., described in publications EP-681 390 and EP-572 252, but they do not provide the user with sufficient and easily obtainable information about making a call.

For instance, GSM phones include a known solution whereby pressing the ABC key, for example, causes the display to display a text showing the name linked to each number in the phone number memory, but this function is difficult for an elderly person to perform. On the other hand, this type of function is not sufficiently clear and informative.

Another problem associated with solutions according to the prior art is that the user may accidentally call an emergency number, for example, whereupon an ambulance or the police make an unnecessary visit.

Publication WO-94/01958 describes a device intended for use in a vehicle, equipped with a hands-free function including a voice-controlled audio menu that supplements or replaces a normal visual menu. The audio menu facilitates use of the device, but the device is still deficient when considering its use by elderly people and other persons with special needs.

In receiving a call with GSM phones, for example, the use of A-subscriber recognition is known whereby it is possible to show the name of the caller on the display but said solution does not provide sufficient noticeable information.

The purpose of the present invention is to bring forth a new procedure and arrangement that avoids the problems associated with solutions of the prior art.

### BRIEF SUMMARY OF THE INVENTION

Said purpose is achieved by means of a procedure according to the present invention characterized in that while displaying graphic information identifying owners of dial numbers shown on a display, a move occurs from one main category of graphic memory to another main category and within a desired main category, a move occurs between subcategories and/or members of said main category. Said purpose is achieved by means of a telecommunication terminal arrangement characterized in that said graphic memory comprises a menu structure, which comprises several main categories, and said main categories comprise one or more subcategories and/or members of said main category.

The solution according to the present invention is based on the idea that the terminal device implements a graphic memory, which is linked to function together with a dial number memory/connection code memory.

The solution, according to the present invention, achieves several advantages. A device according to the present invention is very informative as it shows the user graphic information, e.g., a picture of a relative, to inform the user that a number retrieved from the number memory is precisely the number of the relative the user wishes to call. The user can unconcernedly give a command to make a call whereupon the phone begins to make a phone connection to said relative. Advantageous realizations and other specific realizations of the present invention emphasize the advantages of the invention. The telecommunication connection may be a voice connection, data connection or other connection.

The present invention is explained in more detail in the following, with references to the enclosed drawings.

### BRIEF DESCRIPTION OF SEVERAL VIEWS OF THE DRAWINGS

FIG. 1 presents a block diagram of an arrangement according to one embodiment.

FIG. 2 presents a first embodiment of an arrangement.

FIG. 3 presents a menu structure of a graphic memory.

FIG. 4 presents a menu structure illustrating one main category and a subcategory of said category.

FIG. 5 presents another embodiment of a display of a telecommunication terminal arrangement according to FIG. 2.

### DETAILED DESCRIPTION

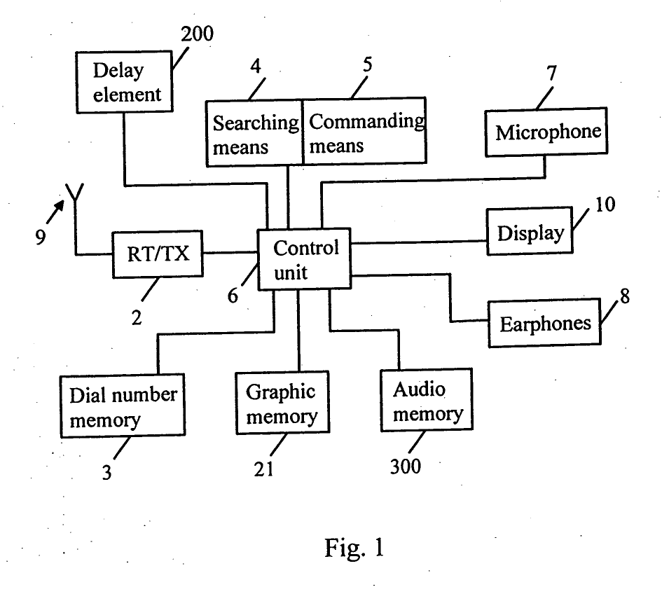

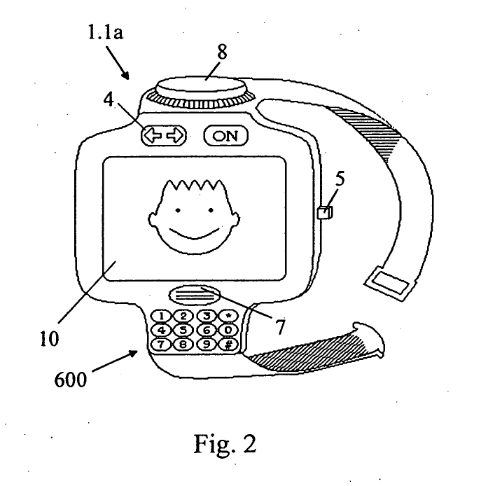

Referring to the figures, particularly FIGS. 1-2, the object of the present invention is a telecommunication terminal arrangement 1 and a procedure used therein for making a telecommunication call and answering a telecommunication call. To begin with, the present invention is described as far as making a call is concerned.

The telecommunication terminal arrangement 1 comprises a transceiver 2, a dial number memory 3, i.e., a phone number memory 3, means of searching 4 used to locate a phone number from said phone number memory 3, and means of commanding 5 used to command said transceiver to attempt to make a call to a phone number retrieved from said phone number memory. Said arrangement also comprises a control unit 6, a microphone 7, earphones 8, an antenna 9, and a display 10. A dial number refers to an actual number or its code.

A telecommunication terminal arrangement 1 according to the present invention comprises a graphic memory 21 including graphic information which illustrates the owners of said phone numbers included in said phone number memory 3, which graphic memory is linked to function together with said phone number memory 3 so that while directly or indirectly browsing said phone number memory 3 said device is arranged to display graphic information related to said number (being currently accessed during said browsing procedure) on a display 10 included in said arrangement and/or a display connected to said arrangement.

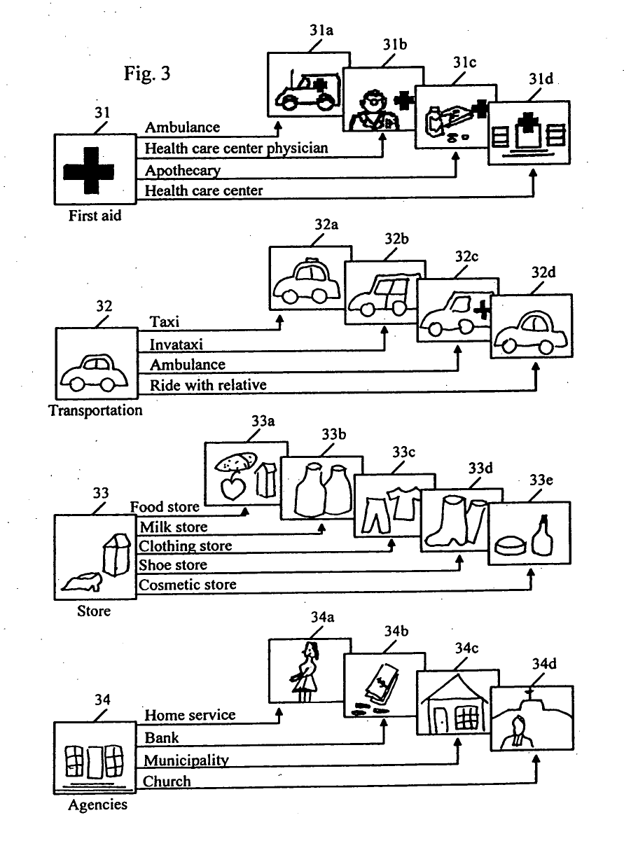

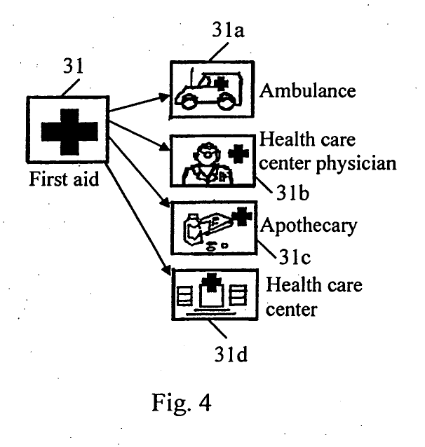

Referring to FIG. 3, an advantageous embodiment of the present invention comprises a menu structure 30 comprising several main categories 31-34 and said main categories comprise one or more subcategories and/or members 31a-31d, 32a-32d, 33a-33d, 34a-34d of said main category. Said main categories of said menu structure 30 include one or more of the following main categories: health care services 31, transportation services 32, stores 33, authorities/agencies 34, relatives, friends, financial institutions. The example in FIG. 4 illustrates a health care services main category 31 and its subcategories 31a-31d. Said subcategories are ambulance 31a, health care center physician 31b, apothecary 31c, and health care center 31d.

In an advantageous embodiment of the present invention, said display 10 is a touch, pressure or otherwise sensitive display which also forms a means of commanding used to command said transceiver 2 to begin directly or indirectly making a call to a final retrieved phone number. In this case, separate means of commanding are not necessary, making said device easier to use.

Direct (directly connected to a telecommunication network) calling means that, e.g., a bracelet-type complete device 1 calls a cellular network base station, for example, and thereby a final phone number. Indirect calling means that, e.g., a bracelet-type device 1 wirelessly first calls a terminal (not presented) included in said telecommunication terminal arrangement located in an elderly person's residence, and said terminal is connected to a telephone network via a normal fixed connection.

Referring especially to FIG. 2, in an advantageous embodiment of the present invention said arrangement 1 is primarily formed into a single entirety, advantageously in the form of a bracelet la, which comprises said means. i.e., a transceiver 2, a phone number memory 3, a graphic memory 21, means of searching 4, means of commanding 5, a display 10 and/or a display connection, earphones 8 and/or an earphone jack, and a microphone 7 and/or a microphone connector. In such a case said device is compact and easy to use.

In an advantageous embodiment of the present invention, said arrangement 1 is realized using a cellular radio phone, such as a cellular radio phone operating in a GSM, DCS or CDMA system. Naturally, other types of networks and their terminal technologies are suitable.

Referring mainly to FIG. 1, it is stated that in an advantageous embodiment of the present invention, said display is a separate unit apart from an integrated entirety formed by said transceiver 2, phone number memory 3, graphic memory 21, means of searching 4, and means of commanding 5, said separate unit being connected by wire or wirelessly to said integrated entirety. In such a case in an advantageous embodiment, said display is a television. In this embodiment, it is possible to form a large color image. Nevertheless, according to the present applicant's observations, the preferred embodiment is in accordance with FIG. 1, i.e., said display 10 is included in said device 1a, because in that case said display is always with the user.

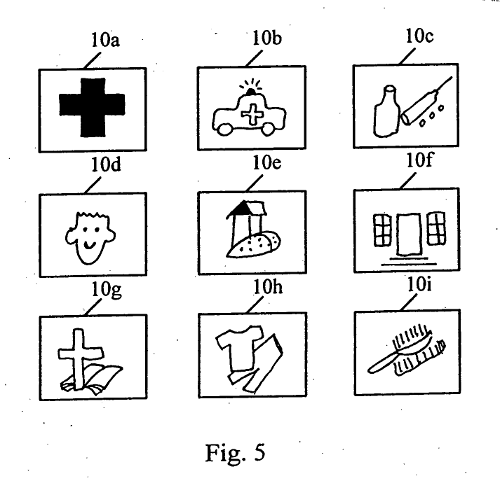

From the standpoint of a procedure, this is a question of a procedure in conjunction with making a telecommunication call. In said procedure, means of searching 4 included in a telecommunication terminal arrangement 1 are used to directly or indirectly at least partly browse through phone numbers stored in said telecommunication terminal arrangement to locate a desired phone number, and means of commanding 5 included in said telecommunication terminal arrangement are used to command a transceiver 2 of said telecommunication terminal to begin directly or indirectly making a call to a final retrieved phone number. In an embodiment including a display like the one presented in FIG. 1, the term at least partly browse means that naturally, a person does not need to browse through all of said phone numbers and/or all of said images, but rather, browsing is performed until the user has caused the graphic information linked to the desired phone number to be displayed. In an embodiment including a display like the one presented in FIG. 5, the term at least partly browse means that the user directly selects the desired image (and the number linked to said image).

In the procedure according to the present invention, while directly or indirectly browsing said phone numbers said arrangement retrieves graphic information identifying each phone number from said graphic memory of said telecommunication terminal arrangement and displays said graphic information on said display 10 included in said telecommunication terminal arrangement.

The term indirect browsing is illustrated by means of the following advantageous embodiment. In an advantageous embodiment of the present invention, indirect, at least partial browsing of said phone numbers is performed by at least partly browsing through said graphic memory 21 linked to said phone number memory 3. Basically, however, this is a question of browsing through said phone number memory 3 because the contents of said phone number memory 3 are linked by pairs with the contents of said graphic memory 21. At the same time, the phone number linked to said displayed graphic information can be retrieved from said phone number memory 3. Said embodiment is advantageous because said phone number and/or a name linked to said phone number can also be displayed and also because said number is already retrieved, whereupon the number associated with said image is known before the means of commanding 6 are used to give a command to make a call. In another embodiment of the present invention, a number is retrieved from said number memory only for the graphic information that at which the user ceases to browse the graphic memory 21 and commences to press or otherwise activate means of commanding 5, i.e., a phone number is retrieved only for the graphic information corresponding to the number to which the user wishes to call. The advantage of this embodiment is quicker, simpler operation.

The term direct partial browsing is illustrated by means of the following advantageous embodiment. In an advantageous embodiment of the present invention, direct, at least partial browsing of said phone numbers is performed by at least partly browsing through the phone number memory 3 linked to the graphic memory 21. The advantage of this embodiment is that the number is known and it can be shown on the display 10.

In an advantageous embodiment of the present invention, the graphic images associated with a portion of the connection code may be displayed on the telecommunication terminal in response to entering said portion of the connection code. For example, if there are ten stored graphical images and sounds (i.e. the system can store sounds or images or both. The user can hear sounds relating to the available connection codes (phone numbers) so that he/she does not have to look at the screen to see the graphic, but can simply listing to the audible clips being played in succession or according the touch screen entries of the user) of the parties to be called which each have the same first connection codes, as 555-1212, 555-1213, 555-1214, or for international numbers: 101.000.000.000, 102.000.000.000, 103.000.000.000, 104.000.000.000, 105.000.000.000, 106.000.000.000, 107.000.000.000, 108.000.000.000, 109.000.000.000, etc., which will be displayed on the virtual terminal when the first digits of these connection codes are entered.

If desired, the process can be repeated to include additional connection codes to further codes as 101.000.000.000a, 101.000.000.000b, 101.000.000.000c, etc. to cut out undesired matches/images. The user can proceed further to enter more codes, if the original ten graphical images and/or sounds are still not a desired match.

Each picture and/or sound has the own connection code, so the owner/sender can set the system to run automatically to the terminal (phone handset) in background/virtual process for the virtual operator (computer system).

The above embodiment may be useful when there are a large number of graphical images.

The automatic scrolling feature may be used to scroll through the matching images to isolate the desired image. In this embodiment, the user may input a digital catalog (i.e. a data base of numbers) of the terminal or from the virtual operators information to its connection codes (portions of phone numbers) and then gives a keystroke or audio command to begin scrolling through the images which matched the initially entered connection codes. In this case, audible commands may be used in place of keystrokes to access the phone number data base, further eliminating the user's distraction from whatever he/she is doing at the time.

To put in another way, because the typical user will amass so many contacts in his mobile device, and due to the nature of mobile devices, often one does not have good concentration when using them. It is necessary to narrow the search field with keyboard inputs, which therefore means numbers or letters, but from there, a hierarchy of graphical images can be displayed, with a touch screen can be displayed. In one embodiment, the user will input data from the keyboard. It can be an area code (connection code) input or spell out a category (friends, family, business, etc) or the first digit of a name, location, etc. This system will fill the name-based list of the category. People better recognize faces and sounds than numbers. This innovation will help too the disable a call in process.

The system will recognize the pattern and provide a graphical display of choices. If, for example, the input was A-N (which corresponds to 2-6 on a US phone keyboard, it could display all 1) all animal graphics, 2) all names starting with AN—like Anne, Anderson, etc., and 3) graphical images for persons having 2-6 area code.

The user could open the search by the voice, using voice name, voice place, voice address, then search by selecting an image relating to the above categories and then further images under that category would appear. In short, the with a single keyboard entry of one or more digits, the user then is able to make select further hierarchical categories based on visual images or cues on a some method as a touch screen of adjacent the image on a keypad. This prevents undue user distraction. Note that the image displayed may be a previously input image relating to a single phone number or a category image which is prestored in the system or added by user selection. Graphical images which are category type may be drawings or sketches which do not require high resolution (meaning smaller thumbnails can be displayed in great density on a small screen). The system will preferably use such simpler graphics and setting voice when available to show more choices to the user of the information as on one screen or a sound.

Thus the use of hierarciachial multimedia system with images and sounds (and voice command) makes it possible for the user to quickly recognize the party to be dialed and then select by voice command, keyboard entry or touch screen entry, that party.

In an advantageous embodiment of the present invention, said graphic information is color and/or black and white graphic information similar to photographic information.

In FIG. 1, the graphic information shows an elderly person's grandchild, for example.

In an advantageous embodiment of the present invention, said graphic information covers a significant part, advantageously at least 50-80%, perhaps even 100% of the display of said telecommunication terminal arrangement 1. Most advantageously, said display 10 is almost completely covered except for a part of said display that conventionally shows a phone number or the name of the owner of a phone number or other information.

In an advantageous embodiment of the present invention, a move is made from one image to the next in the graphic memory by touching, pressing or otherwise activating said display, for example by using means of searching 4 to move to the next graphic information. This feature simplifies use.

In an advantageous embodiment of the present invention, after a specified time delay said graphic information is automatically replaced by said next graphic information. A delay element is represented by block 200. This type of auto scrolling facilitates use of the device. In an advantageous embodiment said time delay is a few seconds, for example, 3-6 seconds.

The following also refers to FIG. 5. FIG. 5 presents second embodiment of a display 10 of a telecommunication terminal arrangement according to FIG. 2, which version comprises several display parts 10a-10i. In said version of FIG. 5, all said display units display graphic information, and the user selects one of these by pressing or otherwise indication a selection. Thus, said graphic information is already displayed before said user has performed a search. However, according to the applicant's observations, said version is not as advantageous as the previously described version, where said images are displayed by turn, allowing a large image as shown in FIG. 2. The version presented in FIG. 5 is included in the basic idea of the present invention, because the user's deliberation and selection of one image from among many can be considered partial browsing of phone numbers, where browsing is performed only for one number, i.e., the selected number.

In a certain other embodiment FIG. 5 can be interpreted as such that the images are images of a main menu, and images found “under” said main category are images belonging to said main category. This means, for example, that “under” the main category image icon in display part 10f, which presents agencies, there is graphic information related to agencies, which is accessible by pressing, and telephone numbers linked to said graphic information are naturally stored in said phone number memory 3.

In an advantageous embodiment of the present invention, the search for a number can be made even clearer by using audio memory 300 in addition to graphic memory. Said audio memory uses a hearing aid 8 or speaker or other means of producing sound to relay an audio signal informing the user the identity of the owner of the phone number being currently accessed while browsing said phone number memory 3. Said audio signal is created in conjunction with said graphic information, providing the most effective result. Most advantageously said audio memory 300 and graphic memory 21 are essentially the same means of memory, which includes multimedia-type graphic and audio information. Said stored graphic and audio information can be realized by means of a suitable integrated memory circuit.

Said arrangement may also include a conventional keyboard 600, particularly when a device is in question that also functions as a normal terminal device of a cellular radio network. Said device may also comprise means or at least a connection by which the information content of memory 21 and/or 300 can be modified.

Also referring to FIG. 1, the object of the present invention is a procedure and telecommunication terminal arrangement in conjunction with receiving a telecommunication call in call reception. Said device comprises a receiver part 2, RX, a connection code memory (e.g., a phone number memory) 3, and means of identifying 700 used to identify a connection code in a telecommunication call to said telecommunication terminal. Said arrangement also comprises a graphic memory 21 including graphic information which illustrates the owners of said connection codes included in said connection code memory 3, which graphic memory is linked to function together with said connection code memory 3 and means of identifying 700 so that said arrangement displays graphic information related to said owners of said connection codes on a display 10 included in said arrangement and/or a display connected to said arrangement. In an example situation according to FIGS. 1 and 2, said display 10 of said arrangement 1 displays the image of the person calling his/her own number in said arrangement.

The part of the procedure of the present invention concerning reception of a telecommunication call is a question of displaying graphic information identifying the owner of said connection code found in said graphic memory 21 included in said telecommunication terminal arrangement on said display 10 of said telecommunication terminal arrangement. Thus, said device identifies the number from which a call has come and retrieves graphic information corresponding to said number from said graphic memory and displays said graphic information on said display 10.

Thus, said connection code may be a caller's phone number, but said connection code may also be e.g., an identifying code or similar code on which basis said telecommunication arrangement retrieves information related to said code from said graphic memory, which information may be advertisement information, for example.

The effect can be enhanced by presenting audio information describing said caller/advertiser.

Although the present invention is described in detail above with references to example embodiments presented in the enclosed figures, it is clear that the present invention is not limited by the presented example embodiments but rather it can be modified in many ways to the extent of the innovation described by the enclosed claims.

We Claim:

1. A method for assisting a user with making a telecommunication call from a portable phone, the method comprising:
storing connection codes on a connection code memory;
storing graphic images on a graphic memory in a hierarchical structure by main categories and at least one sub-category, said graphic images relating to the identity of owners of said connection codes;
sequentially displaying individual graphic images on a display of a telecommunication terminal arrangement while browsing directly or indirectly at least partly through said graphic images stored on said graphic memory of said telecommunication terminal arrangement to locate a desired graphic image, wherein while browsing said graphic images identifying said owners of said connection codes, accessing said connection codes first by user selection of a plurality of sequential graphic images of one main category of said graphic memory to another main category, and within a desired main category, at least one sub-category wherein at least one of a subcategory and a main category comprises at least one graphic image corresponding to a connection code; and
establishing a telecommunication call with a transmitter included in said telecommunication terminal arrangement automatically to a connection code connected to said desired graphic image displayed in said selected category on said display when receiving a selection of said desired graphic image.

2. The method according to claim 1, further comprising:
storing audio recordings on an audio memory linked to said graphic memory, said audio recordings capable of identifying the owner of the connection code and of the category selected; and
playing at least one audio signal with each graphic image corresponding to a selected viewed category and owner of connection codes while browsing said graphic images;
wherein the call is established by selecting said desired graphic image itself.

3. The method according to claim 1, wherein graphic images appear in time separated sequence until stopped by a user selection.

4. The method according to claim 1 wherein a graphic image fills a significant part of said display of said telecommunication terminal arrangement while the remaining portion of the image displays the connection code.

5. A method in conjunction with making a telecommunication cali, the method comprising:
storing connection codes on a connection code memory accessible by direct browsing by connection code number or portion thereof;
additional storing graphic images on a graphic memory in a hierarchical structure by main categories and at least one sub-category, said graphic images linked to the connection codes and the owners thereof;
displaying graphic images on a display of a telecommunication terminal arrangement in response to a partial direct browsing of at least part of said connection code, whereupon said graphic images are displayed which meet the match of said part of the connection code, whereupon the user may input further portions of the connection code so as to narrow the number of graphic images displayed, or continue browsing through graphic images only to locate a desired graphic image, wherein while browsing said graphic images identifying said owners of said connection codes on said display,
establishing a telecommunication call with a transmitter included in said telecommunication terminal arrangement automatically to a connection code connected to said desired graphic image displayed on said display when receiving a selection of said desired graphic image.

6. The,method according to claim 1, wherein the user may select the desired graphic image by touching the screen.

7. The method according to claim 1, wherein within said graphic memory, a move occurs to the next graphic image by a graphic image.

8. The method according to claim 1, that wherein after a specific delay controlled by a delay unit, said displayed graphic image is replaced by the next graphic image.

9. A portable telecommunication terminal arrangement, which comprises:
a transmitter;
a graphic display;
a connection code memory in which a plurality of connection codes is stored;
a hierarchical graphic memory in which a plurality of graphic images is stored, in a hierarchical structure by main categories and at least one sub-category, said graphic images being linked to the connection codes which are related to the identity of the owners of said codes;
a search routine capable of locating a desired connection code by first displaying sequentially a plurality of graphics corresponding to main categories and, upon selection, sequentially displaying a plurality of connection codes and associated graphic images; and
a transmitter to automatically establish a telecommunication call to a connection code connected to said selected graphic image displayed on said display, when receiving a selection of said desired graphic image, the connection code being retrieved from said connection code memory.

10. The arrangement according to claim 9, wherein the main categories further include a plurality of sub-categories, each graphically displayed, and wherein said connection codes are displayed within at least one sub-category, said connection codes being displayed by a graphic image.

11. The arrangement according to claim 9, wherein said display is a touch, pressure, or otherwise sensitive display for receiving user selection of graphic image.

12. The arrangement according to claim 9, wherein the arrangement is in the form of a bracelet, and further includes an audio storage unit associated with said graphic memory and capable of storing an audio message to assist the user in identifying the owner of the category and communication code corresponding to a graphic image, and
a playback unit, responsive to the appearance of a graphical image, to play the audio message.

13. The arrangement according to claim 12, wherein the graphic display is touch responsive, so that the user may select a category and communicate code by touching the display when the desired audio message is heard.

14. The arrangement according to claim 9 wherein the graphical image is a moving image.
